(19) United States
(12) Patent Application Publication
(10) Pub. No.: US 2020/0329504 A1
(43) Pub. Date: Oct. 15, 2020

(54) MsgB Format In Two-Step Random Access In Mobile Communications

(71) Applicant: MediaTek Singapore Pte. Ltd., Singapore (SG)

(72) Inventors: Mehmet Kunt, Cambridge (GB); Pradeep Jose, Cambridge (GB)

(21) Appl. No.: 16/846,245

(22) Filed: Apr. 10, 2020

Related U.S. Application Data
(60) Provisional application No. 62/832,356, filed on Apr. 11, 2019.
(60) Provisional application No. 62/886,443, filed on Aug. 14, 2019.

(51) Int. Cl. H04W 74/08

(52) U.S. Cl. CPC H04W 74/0833

(57) ABSTRACT

An apparatus implemented in a user equipment (UE) transmits a first message (MsgA) in a two-step random access (RA) procedure to a wireless network. In response, the apparatus receives a second message (MsgB) in the two-step RA procedure from the wireless network. In an event that the MsgB comprises a backoff subheader, a content of the backoff subheader in the two-step RA procedure is identical to a content of a backoff subheader in a four-step RA procedure. MsgB comprises a FallbackRAR subPDU, the format of the FallbackRAR subPDU in the two-step RA procedure is identical to the format of a RAPID/RAR subheader and RAR payload in Msg2 in a four-step RA procedure. MsgB comprises a SuccessRAR subPDU, the format of the SuccessRAR subPDU in the two-step RA procedure uses the format of the SuccessRAR subPDU described herein.

### CROSS REFERENCE TO RELATED PATENT APPLICATION(S)

The present disclosure is part of a non-provisional application claiming the priority benefit of U.S. Patent Application No. 62/832,356, filed on 11 Apr. 2019, and 62/886,443, filed on 14 Aug. 2019, contents of which being incorporated by reference in their entirety.

### TECHNICAL FIELD

The present disclosure is generally related to mobile communications and, more particularly, to techniques pertaining to a format of MsgB in a two-step random access (RA) procedure in mobile communications.

### BACKGROUND

Unless otherwise indicated herein, approaches described in this section are not prior art to the claims listed below and are not admitted as prior art by inclusion in this section.

Under the 3^{rd} Generation Partnership Project (3GPP) specifications for 5^{th} Generation (5G) New Radio (NR) mobile communications, a user equipment (UE) can perform a two-step random access (RA) procedure in lieu of a four-step RA procedure to obtain access to and establish communication with a cell of a mobile network. However, details on certain aspects of implementation of a two-step RA procedure have yet to be defined.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose various schemes, concepts, designs, techniques, methods and apparatuses to address the aforementioned issue. In particular, the present disclosure aims to provide schemes and designs pertaining to a format and contents of MsgB in a two-step RA procedure in mobile communications.

In one aspect, a method may involve a processor of an apparatus, implemented in a user equipment (UE), transmitting a first message (MsgA) in a two-step RA procedure to a wireless network. In response to transmitting the MsgA, the method may also involve the processor receiving a second message (MsgB) in the two-step RA procedure from the wireless network. In an event that the MsgB comprises a backoff subheader, a content of the backoff subheader in the two-step RA procedure is identical to a content of a backoff subheader in a four-step RA procedure. In an event that the MsgB comprises a FallbackRAR sub-protocol data unit (subPDU), the format of the FallbackRAR subPDU in the two-step RA procedure is identical to the format of a RAPID/RAR subheader and RAR payload in Msg2 in a four-step RA procedure. In an event that the MsgB comprises a SuccessRAR subPDU, the format of the SuccessRAR subPDU in the two-step RA procedure uses the format of the SuccessRAR subPDU in accordance with the present disclosure.

In another aspect, an apparatus implemented in a UE may include a transceiver and a processor coupled to the transceiver. The transceiver may be configured to communicate with a wireless network. The processor may transmit, via the transceiver, a first message (MsgA) in a two-step RA procedure to a wireless network. In response to transmitting the MsgA, the processor may receive, via the transceiver, a second message (MsgB) in the two-step RA procedure from the wireless network. In an event that the MsgB comprises a backoff subheader, a content of the backoff subheader in the two-step RA procedure is identical to a content of a backoff subheader in a four-step RA procedure. In an event that the MsgB comprises a FallbackRAR subPDU, the format of the FallbackRAR subPDU in the two-step RA procedure is identical to the format of a RAPID/RAR subheader and RAR payload in Msg2 in a four-step RA procedure. In an event that the MsgB comprises a SuccessRAR subPDU, the format of the SuccessRAR subPDU in the two-step RA procedure uses the format of the SuccessRAR subPDU in accordance with the present disclosure.

It is noteworthy that, although description provided herein may be in the context of certain radio access technologies, networks and network topologies such as 5G/NR mobile networking, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT), Industrial Internet-of-Things (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example design in accordance with an implementation of the present disclosure.

FIG. 3 is a diagram of an example design in accordance with an implementation of the present disclosure.

FIG. 4 is a diagram of a comparison of designs.

FIG. 5 is a diagram of a comparison of designs.

FIG. 6 is a diagram of a comparison of designs.

FIG. 7 is a diagram of a comparison of designs.

FIG. 8 is a diagram of a comparison of designs.

FIG. 9 is a block diagram of an example communication system in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a format of MsgB in a two-step RA procedure in mobile communications. According to the present disclosure, a number of possible solutions may be implemented separately or jointly. That is, although these possible solutions may be described below separately, two or more of these possible solutions may be implemented in one combination or another.

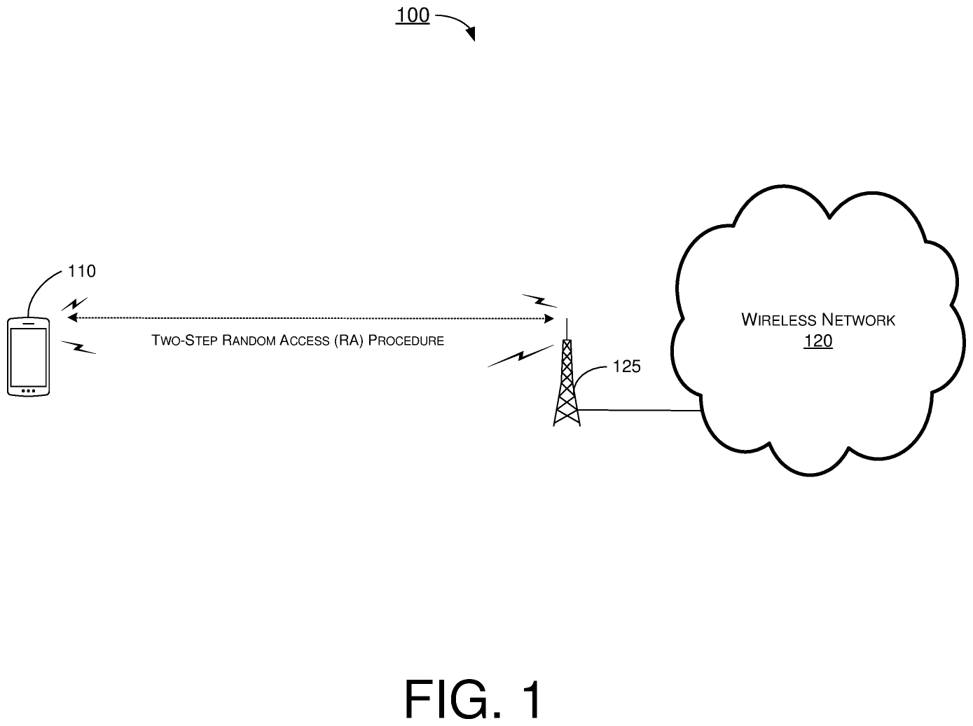

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to a format of MsgB in a two-step RA procedure in mobile communications in accordance with the present disclosure, as described herein.

With respect to backoff, in a four-step RA procedure, backoff is applicable when a number of conditions are met. That is, in case UE 110 has not received a random access response (RAR) from network node 125 with a random access preamble identifier (RAPID) corresponding to the preamble UE 110 has transmitted to network node 125 within a RAR window or in case UE 110 has not received Msg4 that completes contention resolution successfully before the expiry of a contention resolution timer, and in case a backoff subheader is received by UE 110 in a RAR from network node 125, then UE 110 would apply a random backoff before attempting the four-step RA procedure again. According to the 3GPP Technical Specification (TS) 38.321 section 6.1.5, backoff is indicated by the backoff subheader in a RAR.

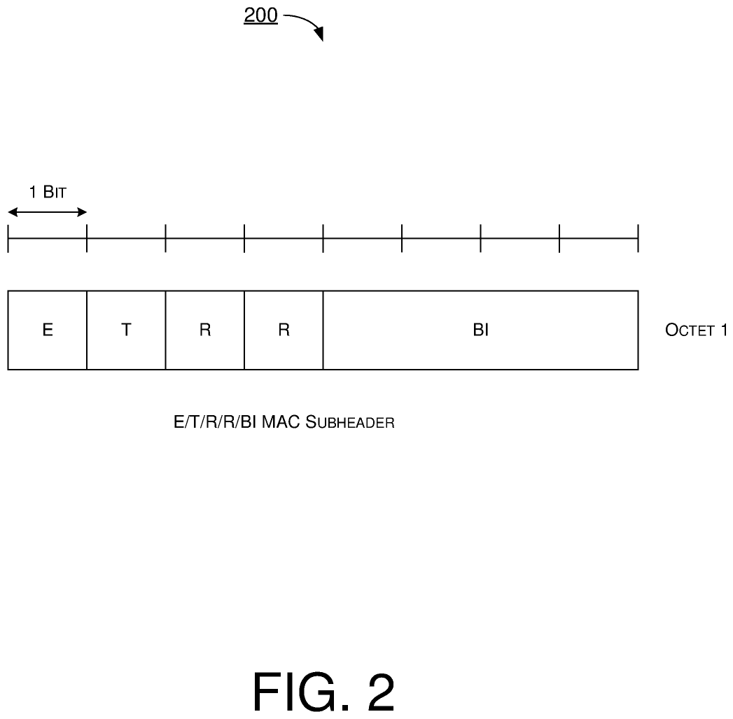

FIG. 2 illustrates an example design 200 of a backoff subheader. Referring to FIG. 2, “E” denotes an extension bit, T-bit may be set to 0, and the two R-bits may be set to 0.

Under a proposed scheme in accordance with the present disclosure, a backoff subheader in a two-step RA procedure may have the same contents as the backoff subheader in a four-step RA procedure. Under the proposed scheme, in case UE 110 receives a backoff subheader in MsgB and in case the response window of MsgB has expired and random access reception has not been considered successful, then UE 110 may apply a random backoff before attempting the two-step RA procedure again. The backoff subheader may be based on Release 15 (Rel-15) of the 3GPP specification for backoff subheader.

With respect to fallback, in a two-step RA procedure, in case network node 125 receives a preamble for MsgA transmission but is not able to decode the physical uplink shared channel (PUSCH) for the MsgA transmission, then network node 125 may instruct UE 110 to fallback to a four-step RA procedure. A fallback request from wireless network 120 to UE 110 is herein referred to as “FallbackRAR.” When UE 110 receives FallbackRAR from wireless network 120, UE 110 may transmit a PUSCH payload of MsgA using Msg3 in a four-step RA procedure and, in such cases, the four-step RA procedure may be followed (e.g., UE 110 would wait for Msg4). The information required in FallbackRAR may be the same information that is included in RAPID/RAR subheader and RAR payload in Msg2 (RAR) of a four-step RA procedure including, for example and without limitation, RAPID, timing advance (TA) command, uplink (UL) grant, and temporary cell radio network temporary identifier (TC-RNTI). Under a proposed scheme in accordance with the present disclosure, FallbackRAR in a two-step RA procedure may have the same format as the RAPID/RAR subheader and RAR payload in a four-step RA procedure.

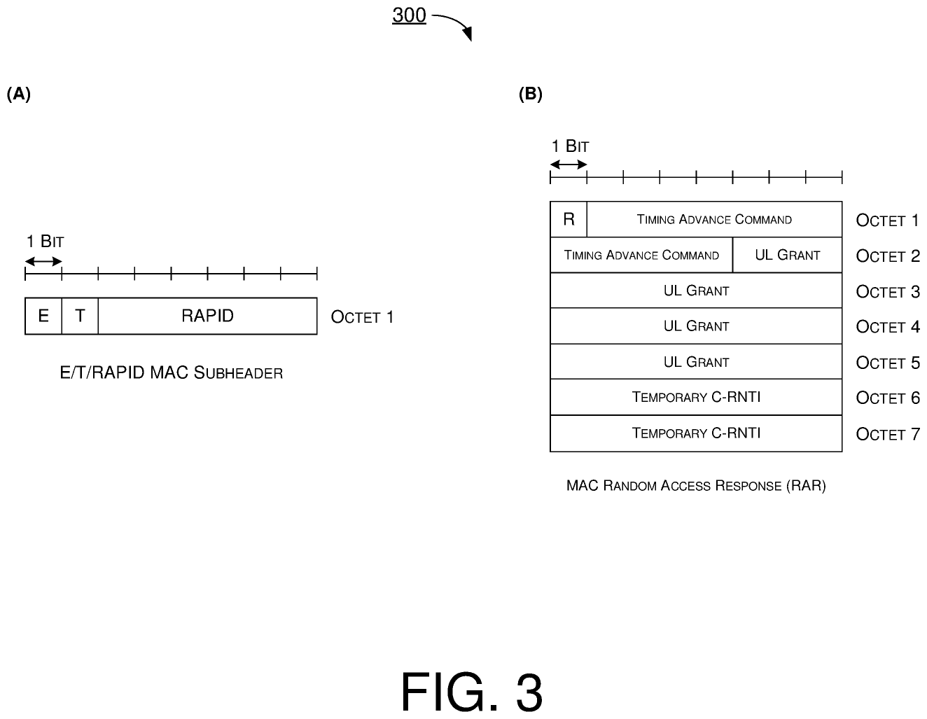

FIG. 3 illustrates an example design 300 of a FallbackRAR. Part (A) of FIG. 3 illustrates a RAPID/RAR subheader. Part (B) of FIG. 3 illustrates a medium access control (MAC) RAR as a FallbackRAR for a two-step RA procedure in accordance with the present disclosure. The FallbackRAR subheader may be based on Release 15 (Rel-15) of the 3GPP specification for RAPID subheader.

With respect to successful contention resolution, in a four-step RA procedure, when UE 110 does not have a cell radio network temporary identifier (C-RNTI), the contention resolution may be completed by Msg4 which contains a UE Contention Resolution ID in a MAC control element (CE) consisting of six octets. In a two-step RA procedure, for the same scenario (e.g., UE 110 does not have C-RNTI), MsgB would need to contain UE Contention Resolution ID. Additionally, MsgB may contain TA command and the C-RNTI assigned to UE 110. The response from wireless network 120 in this scenario is herein referred to as “SuccessRAR” to indicate a successful contention resolution for one UE (e.g., UE 110).

Under a proposed scheme in accordance with the present disclosure, one of the R-bits in the Rel-15 backoff subheader may be set to 1 in order to identify the SuccessRAR subheader. Under the proposed scheme, UE 110 may detect a subheader to be SucessRAR sub-protocol data unit (subPDU) in case this R-bit is set to 1. Moreover, UE 110 may detect a subheader to be a backoff subPDU in case this R-bit is set to 0. The content of MsgB of SuccessRAR may at least include a UE contention resolution ID (six octets), TA command (12 bits) and C-RNTI (two octets). Under the proposed scheme, the UE contention resolution ID may be the first field in the SuccessRAR payload. This may speed up the processing on the part of UE 110. That is, in case UE 110 detects that the UE contention resolution ID in SuccessRAR payload does not match the identity it has transmitted in MsgA, UE 110 may skip to the next subPDU (if present).

In a four-step RA procedure, Msg4 can contain radio resource control (RRC) messages for signaling radio bearers (SRBs) such as, for example, a RRCSetup message. According to TS 38.321 section 6.1.2, Msg4 is encoded using downlink shared channel (DL-SCH) protocol data unit (PDU) format with a logical channel identifier (LCID) field and an L field, with the LCID field identifying logical channel instance of corresponding MAC SDU or type of corresponding MAC CE or padding and with the L field indicating length field of corresponding MAC SDU or variable sized MAC CE in units of bytes. In a two-step RA procedure, MsgB may also contain RRC messages for SRB (or other data such as MAC CEs or data radio bearer (DRB) data). Under a proposed scheme in accordance with the present disclosure, part of MsgB that contains SRB RRC message(s) and/or other data (e.g., MAC CEs or DRB data) may be encoded using DL-SCH PDU format with LDCI/L fields as in TS 38.321 section 6.1.2 (herein referred to as “DL-SCH PDU Container”). This may reduce the complexity of the decoding process on the part of UE 110 (for decoding MsgB). Moreover, UE 110 may re-use the Rel-15 decoding algorithms for DL-SCH PDU with LCID/L fields for this part of MsgB.

Under a proposed scheme in accordance with the present disclosure, a DL-SCH PDU container may correspond to a SuccessRAR and may be for a specific UE (e.g., UE 110). Under the proposed scheme, the DL-SCH PDU container (e.g., MAC subPDU(s) for MAC service data unit (SDU)) may immediately follow the corresponding SuccessRAR. This may make it easier for UE 110 to find the DL-SCH PDU container (e.g., MAC subPDU(s) for MAC SDU) corresponding to the SuccessRAR. Additionally, under the proposed scheme, at most one SuccessRAR with corresponding DL-SCH PDU container (e.g., MAC subPDU(s) for MAC SDU) may be present in one MsgB PDU. This may further reduce the effort in decoding MsgB on the part of UE 110. Accordingly, UEs would not need to parse very many LCID/L fields in MsgB. Furthermore, only one UE (with matching UE contention resolution ID) needs to parse the DL-SCH PDU container (e.g., MAC subPDU(s) for MAC SDU) in MsgB.

Under a proposed scheme in accordance with the present disclosure, the SuccessRAR with the DL-SCH PDU container (e.g., MAC subPDU(s) for MAC SDU), if present, may be (e.g., is always) the last FallbackRAR or SuccessRAR subPDU in the MsgB PDU. This means that there may be no SuccessRAR or FallbackRAR subPDU following DL-SCH PDU container (e.g., MAC subPDU(s) for MAC SDU). Therefore, only the UE (e.g., UE 110) with a successful contention resolution (with matching UE contention resolution ID in SuccessRAR) needs to decode the DL-SCH PDU container (e.g., MAC subPDU(s) for MAC SDU). This may additionally reduce the effort in decoding for UEs without matching UE contention resolution ID (and such a UE may skip the remainder of the MsgB PDU).

Under a proposed scheme in accordance with the present disclosure, in order to indicate the presence of the DL-SCH PDU container (e.g., MAC subPDU(s) for MAC SDU) following the SuccessRAR, another R-bit of the two R-bits in the Rel-15 Backoff subheader may be used. Under the proposed scheme, there may be a DL-SCH PDU container (e.g., MAC subPDU(s) for MAC SDU) following a given SuccessRAR in case this R-bit is set to 1. On that note, there may not be a DL-SCH PDU container following the given SuccessRAR in case this R-bit is set to 0.

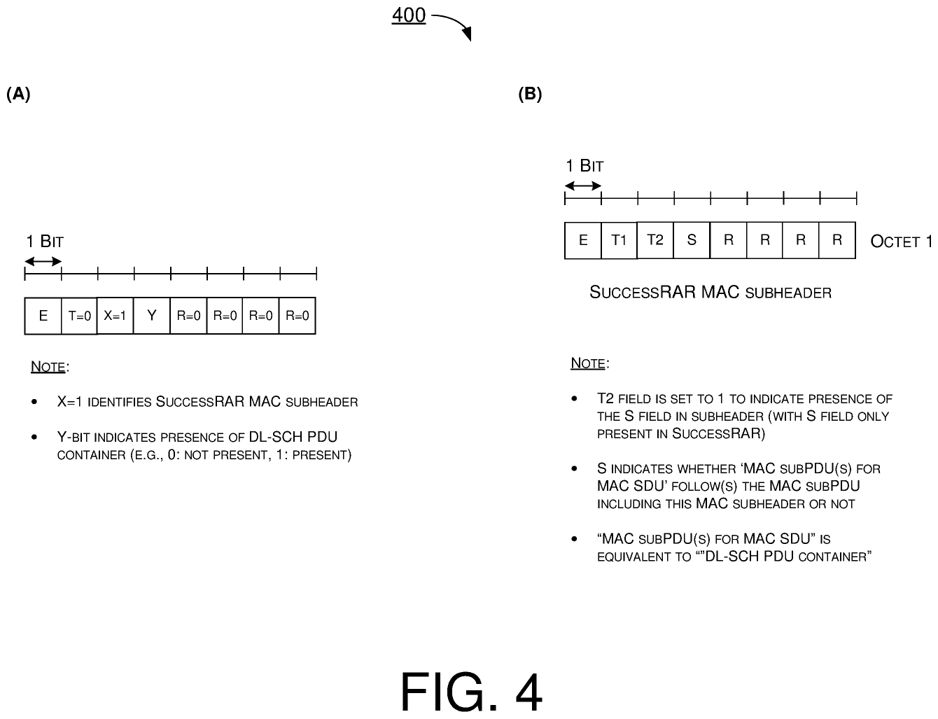

FIG. 4 illustrates a comparison 400 of designs with respect to SuccessRAR subheader. Part (A) of FIG. 4 shows an example SuccessRAR subheader in accordance with the present disclosure. In this SuccessRAR subheader, X may be set to 1 (X=1) to identify this subheader as a SuccessRAR subheader. Moreover, Y may be set to 0 or 1 to indicate whether DL-SCH PDU container is present (Y=1) or not present (Y=0). Part (B) of FIG. 4 shows a SuccessRAR MAC subheader in a change request (CR) for the 3GPP MAC specification. The T2 field may be set to 1 to indicate the presence of the S field in the subheader, and the S field is only present in SuccessRAR. The S field indicates whether ‘MAC subPDU(s) for MAC SDU’ follow(s) the MAC subPDU including this MAC subheader or not. The term “MAC subPDU(s) for MAC SDU” is equivalent to “DL-SCH PDU container” herein.

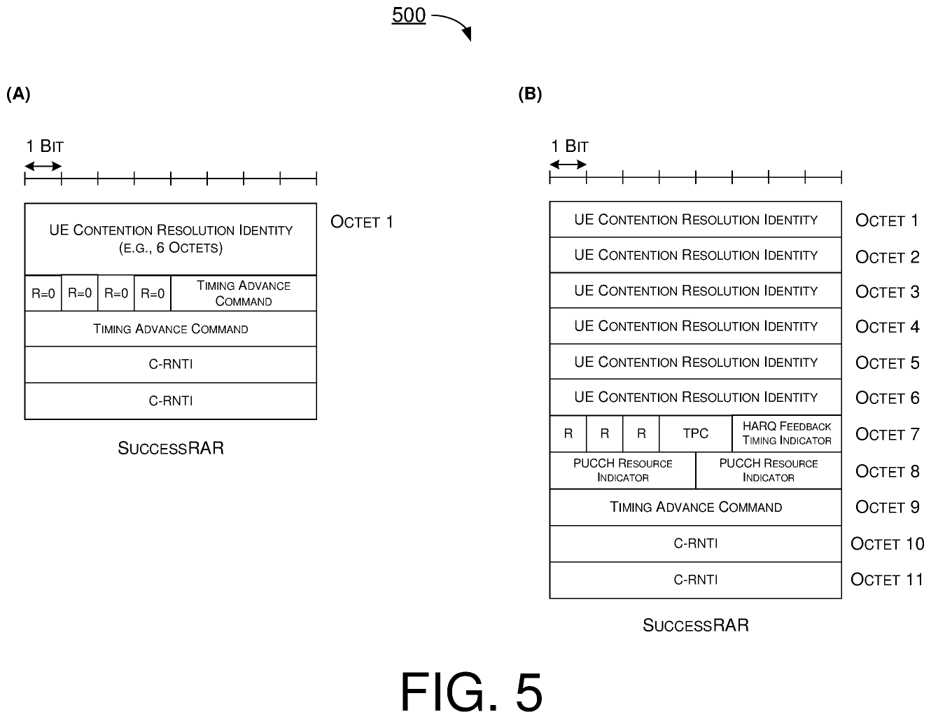

FIG. 5 illustrates a comparison 500 of designs with respect to SuccessRAR. Part (A) of FIG. 5 shows payload of an example SuccessRAR in accordance with the present disclosure. Part (B) of FIG. 5 shows a SuccessRAR in a CR for the 3GPP MAC specification. Additional fields such as transmit power control (TPC), hybrid automatic repeat request (HARQ) feedback timing indicator, and physical uplink control channel (PUCCH) resource indicator were introduced in the MAC specification CR.

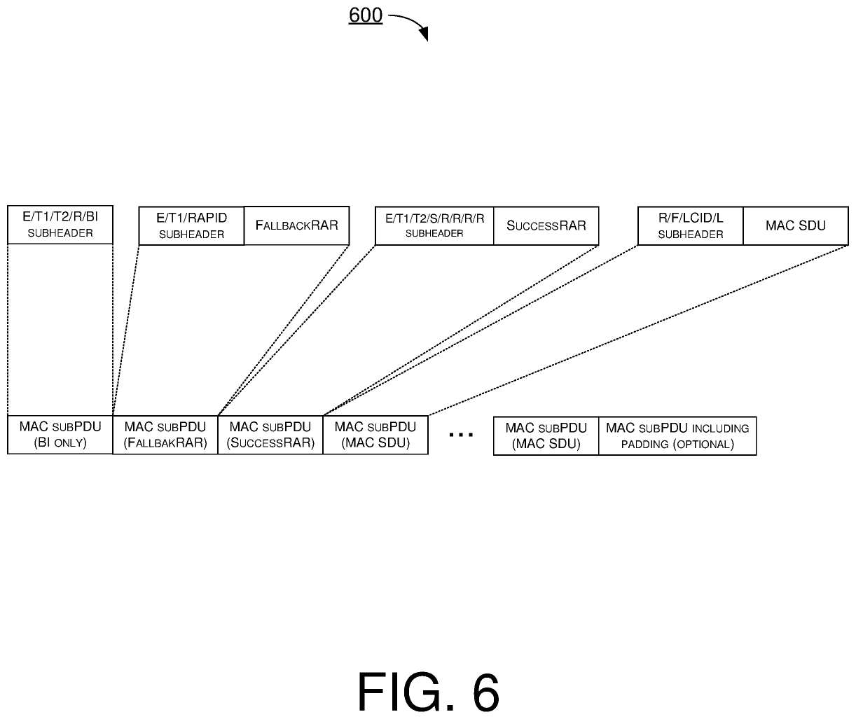

FIG. 6 illustrates a comparison 600 of designs with respect to DL-SCH PDU container (MAC subPDU(s) for MAC SDU). Under a proposed scheme in accordance with the present disclosure, as one option, there may be zero or one SuccessRAR subPDU with DL-SCH PDU container within one MAC PDU. SuccessRAR with the DL-SCH PDU container field (if present) may be (e.g., always be) the last subPDU in the MAC PDU. The length of the DL-SCH PDU container may be determined implicitly by the subPDUs contained in it (e.g., by parsing the contained PDU). On the other hand, according to the MAC specification CR, at most one ‘MAC subPDU for success RAR’ indicating presence of ‘MAC subPDU(s) for MAC SDU’ is included in a MAC PDU. MAC subPDU(s) for MAC SDU are placed immediately after the ‘MAC subPDU for success RAR’ indicating presence of ‘MAC subPDU(s) for MAC SDU’.

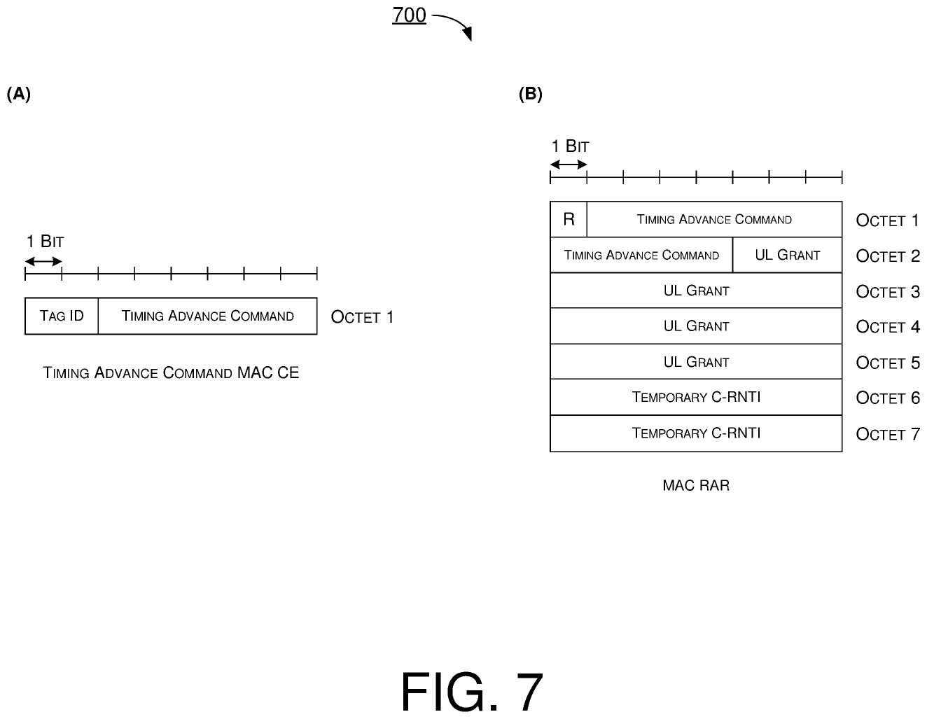

FIG. 7 illustrates a comparison 700 of designs with respect to TA command MAC CE. In a four-step RA procedure, the initial TA is provided to the UE (e.g., UE 110) in the MAC payload for RAR. It consists of 12 bits according to TS 38.321 section 6.2.3. Further adjustment to TA can be indicated by wireless network 120 by TA command MAC CE and consists of 6 bits according to TS 38.321 section 6.1.3.4. The TA is applied by UE 110 according to TS 38.213 section 4.2. The TA command is sent in RAR and consists of 12 bits. In a two-step RA procedure, the initial 12-bit TA needs to be indicated to the UE (e.g., UE 110) in the network response for MsgA. In case the UE has C-RNTI, the response message would be addressed with C-RNTI and would be encoded in DL-SCH PDU format including LCID/L fields (as in TS 38.321 section 6.1.2). In such cases, the initial 12-bit TA command needs to be sent to the UE in a MAC CE. In Rel-15 of the 3GPP specification, there was no MAC CE that can carry a 12-bit TA command. Under a proposed scheme in accordance with the present disclosure, a new MAC CE carrying a 12-bit TA command may be introduced for two-step RA.

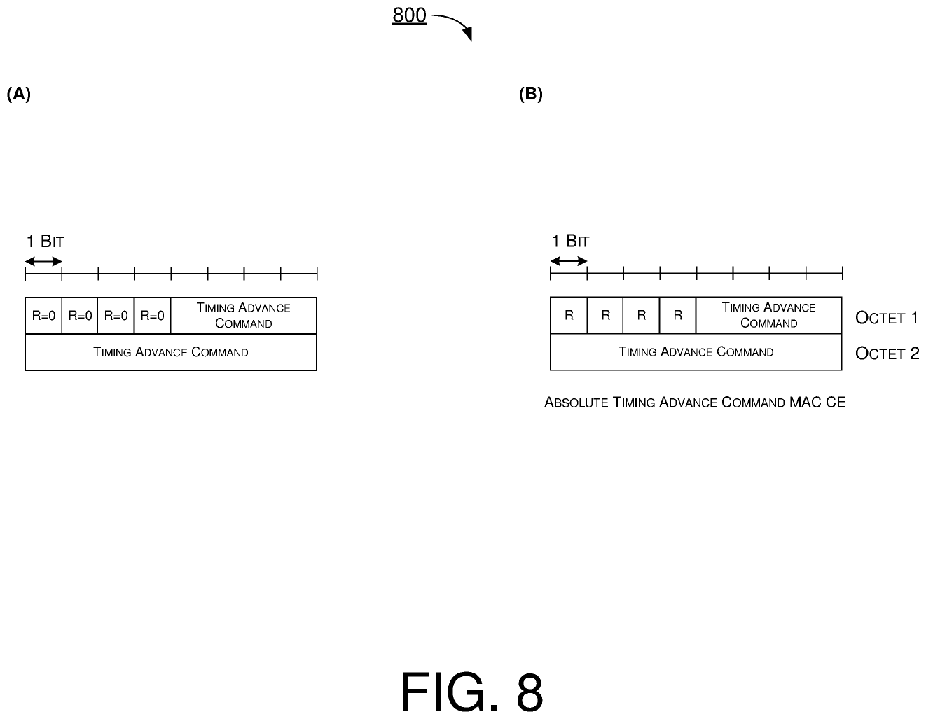

FIG. 8 illustrates a comparison 800 of designs with respect to a 12-bit TA command MAC CE. Part (A) of FIG. 8 shows an example 12-bit TA command MAC CE in accordance with the present disclosure. Part (B) of FIG. 8 shows an absolute TA command MAC CE in the CR for MAC specification.

In view of the above, the present disclosure proposes a number of schemes and/or designs with respect to the format of MsgB in two-step RA procedures. For instance, backoff subheader in a two-step RA procedure may have the same contents as the backoff subheader in a four-step RA procedure. FallbackRAR subPDU in a two-step RA procedure may have the same format as the RAPID and RAR subPDU in a four-step RA procedure. SuccessRAR subheader in a two-step RA procedure may be identified by using one R-bit in the Rel-5 backoff subheader (e.g., X-bit in part (A) FIG. 4). UE contention resolution identity field may be the first field in the SuccessRAR payload. SRB message(s) may be encoded as DL-SCH PDU format in Rel-15 TS 38.321 section 6.1.2 (with LCID/L fields). SRB message(s), if present, may immediately follow the corresponding SuccessRAR. Within one MsgB PDU, there may be at most one SuccessRAR with SRB message(s). SuccessRAR with SRB message(s), if present, may be the last SuccessRAR and/or FallbackRAR subPDU in the MsgB PDU. Whether SRB message(s) follow(s) the SuccessRAR or not may be indicated by using the other R-bit of the two R-bits in the SuccessRAR subheader (e.g., Y-bit in part (A) FIG. 4). When the response message for MsgA is addressed to C-RNTI, a new MAC CE may be specified, defined or otherwise introduced with the 12-bit TA command field.

### Illustrative Implementations

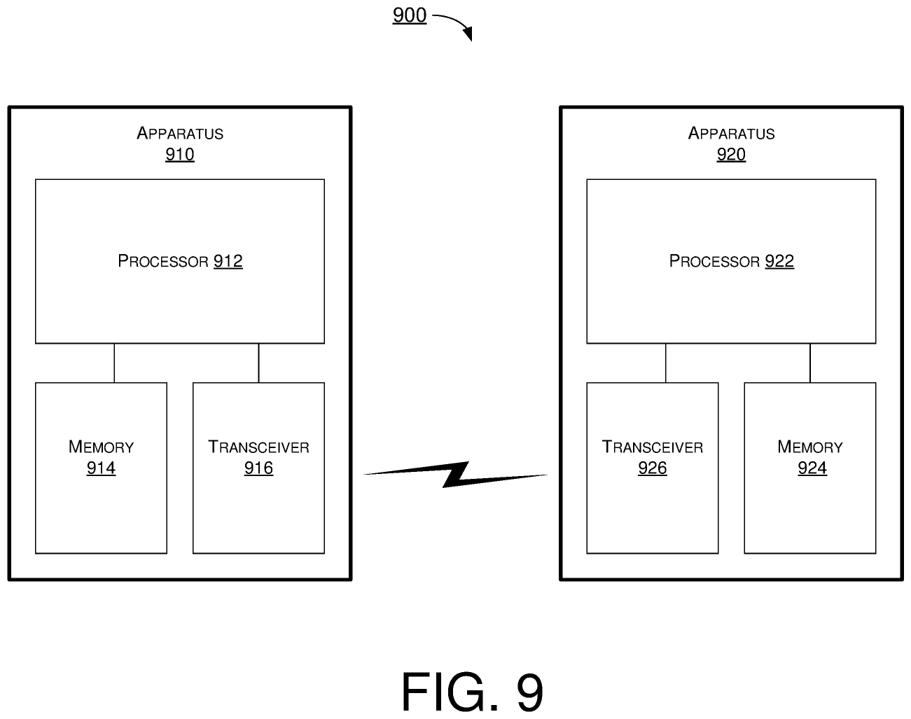

FIG. 9 illustrates an example communication system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to a format of MsgB in a two-step RA procedure in mobile communications, including the various schemes described above with respect to various proposed designs, concepts, schemes, systems and methods described above, including network environment 100, as well as processes described below.

Each of apparatus 910 and apparatus 920 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 910 and apparatus 920 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in an eNodeB in an LTE, LTE-Advanced or LTE-Advanced Pro network or in a gNB or TRP in a 5G network, an NR network or an IoT network.

In some implementations, each of apparatus 910 and apparatus 920 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 910 and apparatus 920 may be implemented in or as a network apparatus or a UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC or RISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to a format of MsgB in a two-step RA procedure in mobile communications in accordance with various implementations of the present disclosure.

In some implementations, apparatus 910 may also include a transceiver 916 coupled to processor 912. Transceiver 916 may be capable of wirelessly transmitting and receiving data. In some implementations, transceiver 916 may be capable of wirelessly communicating with different types of wireless networks of different radio access technologies (RATs). In some implementations, transceiver 916 may be equipped with a plurality of antenna ports (not shown) such as, for example, four antenna ports. That is, transceiver 916 may be equipped with multiple transmit antennas and multiple receive antennas for multiple-input multiple-output (MIMO) wireless communications. In some implementations, apparatus 920 may also include a transceiver 926 coupled to processor 922. Transceiver 926 may include a transceiver capable of wirelessly transmitting and receiving data. In some implementations, transceiver 926 may be capable of wirelessly communicating with different types of UEs/wireless networks of different RATs. In some implementations, transceiver 926 may be equipped with a plurality of antenna ports (not shown) such as, for example, four antenna ports. That is, transceiver 926 may be equipped with multiple transmit antennas and multiple receive antennas for MIMO wireless communications.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a UE (e.g., UE 110), and apparatus 920, as a network node (e.g., network node 125) of a wireless network (e.g., wireless network 120 as a 5G/NR mobile network), is provided below.

In one aspect of a format of MsgB in a two-step RA procedure in mobile communications in accordance with the present disclosure, processor 912 of apparatus 910, implemented in a UE (e.g., UE 110), may transmit, via transceiver 916, a first message (MsgA) in a two-step RA procedure to a wireless network (e.g., wireless network 120) via apparatus 920 as network node 125. Moreover, in response to transmitting the MsgA, processor 912 may receive, via transceiver 916, a second message (MsgB) in the two-step RA procedure from the wireless network via apparatus 920.

In some implementations, in an event that the MsgB comprises a SuccessRAR indicating a successful contention resolution, one of two R-bits in a backoff subheader as defined in Rel-15 of the 3GPP specification may be set to 1 to identify a SuccessRAR subheader in the RA response. In such cases, a first field in a payload of the SuccessRAR may be a UE contention resolution identity field.

In some implementations, in an event that the MsgB includes a backoff subheader, a content of the backoff subheader in the two-step RA procedure may be identical to a content of a backoff subheader in a four-step RA procedure.

In some implementations, in an event that the MsgB includes a RA response (FallbackRAR) indicating a fallback request that the UE falls back to the four-step RA procedure, a format of the FallbackRAR in the two-step RA procedure may be identical to a format of a RAPID subheader and a RAR payload in the four-step RA procedure.

In some implementations, in an event that the MsgB includes one or more SRB messages, the one or more SRB messages may be encoded in a format as a DL-SCH PDU with a LCID field and an L field. In such cases, the one or more SRB messages may immediately follow a corresponding SuccessRAR. Moreover, the SuccessRAR with the one or more SRB messages may constitute a subPDU of a last SuccessRAR or a FallbackRAR in a PDU of the MsgB. Furthermore, whether or not there is at least one SRB message following the SuccessRAR may be indicated by one bit (e.g., Y-bit) in a subheader of the SuccessRAR.

In some implementations, within one PDU of the MsgB, there may be at most one SuccessRAR with one or more SRB messages.

In another aspect of a format of MsgB in a two-step RA procedure in mobile communications in accordance with the present disclosure, processor 912 of apparatus 910, implemented in a UE (e.g., UE 110), may transmit, via transceiver 916, a first message (MsgA) in a two-step RA procedure to a wireless network (e.g., wireless network 120) via apparatus 920 as network node 125. Additionally, processor 912 may receive, via transceiver 916, a second message in the two-step RA procedure, as a response message for MsgA, from the wireless network.

In some implementations, the response message for the MsgA may be encoded in a DL-SCH PDU format, including LCID/L fields, and may include a MAC CE carrying a 12-bit TA command.

### Illustrative Processes

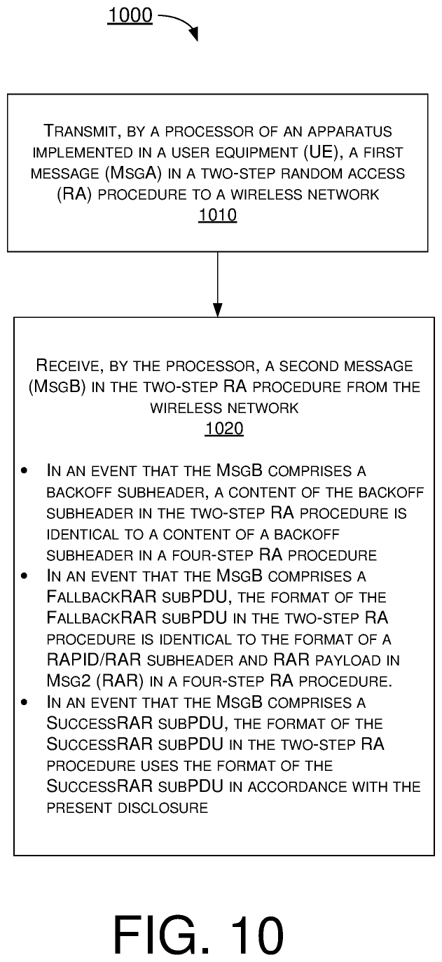

FIG. 10 illustrates an example process 1000 in accordance with an implementation of the present disclosure. Process 1000 may represent an aspect of implementing various proposed designs, concepts, schemes, systems and methods described above, whether partially or entirely, including those pertaining to FIG. 1˜FIG. 9. More specifically, process 1000 may represent an aspect of the proposed concepts and schemes pertaining to a format of MsgB in a two-step RA procedure in mobile communications. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. Furthermore, one or more of the blocks/sub-blocks of process 1000 may be executed iteratively. Process 1000 may be implemented by or in apparatus 910 and apparatus 920 as well as any variations thereof. Solely for illustrative purposes and without limiting the scope, process 1000 is described below in the context of apparatus 910 as a UE (e.g., UE 110) and apparatus 920 as a communication entity such as a network node or base station (e.g., network node 125) of a wireless network (e.g., wireless network 120). Process 1000 may begin at block 1010.

At 1010, process 1000 may involve processor 912 of apparatus 910, implemented in a UE (e.g., UE 110), transmitting, via transceiver 916, a first message (MsgA) in a two-step RA procedure to a wireless network (e.g., wireless network 120) via apparatus 920 as network node 125. Process 1000 may proceed from 1010 to 1020.

At 1020, process 1000 may involve processor 912 receiving, via transceiver 916 and in response to transmitting the MsgA, a second message (MsgB) in the two-step RA procedure from the wireless network via apparatus 920.

In some implementations, in an event that the MsgB comprises a SuccessRAR indicating a successful contention resolution, one of two R-bits in a backoff subheader as defined in Rel-15 of the 3GPP specification may be set to 1 to identify a SuccessRAR subheader in the RA response. In such cases, a first field in a payload of the SuccessRAR may be a UE contention resolution identity field.

In some implementations, in an event that the MsgB includes a backoff subheader, a content of the backoff subheader in the two-step RA procedure may be identical to a content of a backoff subheader in a four-step RA procedure.

In some implementations, in an event that the MsgB includes a RA response (FallbackRAR) indicating a fallback request that the UE falls back to the four-step RA procedure, a format of the FallbackRAR in the two-step RA procedure may be identical to a format of a RAPID subheader and a RAR payload in the four-step RA procedure.

In some implementations, in an event that the MsgB includes one or more SRB messages, the one or more SRB messages may be encoded in a format as a DL-SCH PDU with a LCID field and an L field. In such cases, the one or more SRB messages may immediately follow a corresponding SuccessRAR. Moreover, the SuccessRAR with the one or more SRB messages may constitute a subPDU of a last SuccessRAR or a FallbackRAR in a PDU of the MsgB. Furthermore, whether or not there is at least one SRB message following the SuccessRAR may be indicated by one bit (e.g., Y-bit) in a subheader of the SuccessRAR.

In some implementations, within one PDU of the MsgB, there may be at most one SuccessRAR with one or more SRB messages.

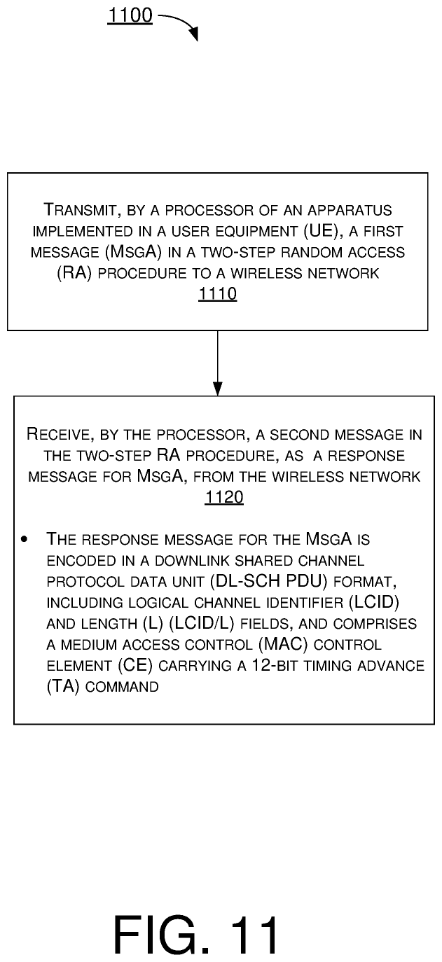

FIG. 11 illustrates an example process 1100 in accordance with an implementation of the present disclosure. Process 1100 may represent an aspect of implementing various proposed designs, concepts, schemes, systems and methods described above, whether partially or entirely, including those pertaining to FIG. 1˜FIG. 9. More specifically, process 1100 may represent an aspect of the proposed concepts and schemes pertaining to a format of MsgB in a two-step RA procedure in mobile communications. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively in a different order. Furthermore, one or more of the blocks/sub-blocks of process 1100 may be executed iteratively. Process 1100 may be implemented by or in apparatus 910 and apparatus 920 as well as any variations thereof. Solely for illustrative purposes and without limiting the scope, process 1100 is described below in the context of apparatus 910 as a UE (e.g., UE 110) and apparatus 920 as a communication entity such as a network node or base station (e.g., network node 125) of a wireless network (e.g., wireless network 120). Process 1100 may begin at block 1110.

At 1110, process 1100 may involve processor 912 of apparatus 910, implemented in a UE (e.g., UE 110), transmitting, via transceiver 916, a first message (MsgA) in a two-step RA procedure to a wireless network (e.g., wireless network 120) via apparatus 920 as network node 125. Process 1100 may proceed from 1110 to 1120.

At 1120, process 1100 may involve processor 912 receiving, via transceiver 916, a second message in the two-step RA procedure, as a response message for MsgA, from the wireless network.

In some implementations, the response message for the MsgA may be encoded in a DL-SCH PDU format, including LCID/L fields, and may include a MAC CE carrying a 12-bit TA command.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus implemented in a user equipment (UE), a first message (MsgA) in a two-step random access (RA) procedure to a wireless network; and
receiving, by the processor, a second message (MsgB) in the two-step RA procedure from the wireless network,
wherein, in an event that the MsgB comprises a RA response (SuccessRAR) indicating a successful contention resolution, one of two R-bits in a backoff subheader as defined in Release 15 (Rel-15) of 3^{rd} Generation Partnership Project (3GPP) specification is set to 1 to identify a SuccessRAR subheader in the RA response.

2. The method of claim 1, wherein a first field in a payload of the SuccessRAR is a UE contention resolution identity field.

3. The method of claim 1, wherein, in an event that the MsgB comprises one or more signaling radio bearer (SRB) messages, the one or more SRB messages are encoded in a format as a downlink shared channel protocol data unit (DL-SCH PDU) with a logical channel identifier (LCID) field and a length (L) field.

4. The method of claim 3, wherein the one or more SRB messages immediately follow a corresponding RA response (SuccessRAR) that indicates a successful contention resolution.

5. The method of claim 4, wherein the SuccessRAR with the one or more SRB messages constitute a sub-protocol data unit (subPDU) of a last SuccessRAR or a RA response (FallbackRAR) indicating a fallback request that the UE falls back to the four-step RA procedure in a protocol data unit (PDU) of the MsgB.

6. The method of claim 4, wherein whether or not there is at least one SRB message following the SuccessRAR is indicated by a Y-bit in a subheader of the SuccessRAR.

7. The method of claim 1, wherein, within one protocol data unit (PDU) of the MsgB, there is at most one SuccessRAR indicating the successful contention resolution with one or more signaling radio bearer (SRB) messages.

8. The method of claim 1, wherein, in an event that the MsgB comprises a backoff subheader, a content of the backoff subheader in the two-step RA procedure is identical to a content of a backoff subheader in a four-step RA procedure.

9. The method of claim 1, wherein, in an event that the MsgB comprises a RA response (FallbackRAR) indicating a fallback request that the UE falls back to the four-step RA procedure, a format of the FallbackRAR in the two-step RA procedure is identical to a format of a random access preamble identifier (RAPID) subheader and a random access response (RAR) payload in the four-step RA procedure.

10. A method, comprising:
transmitting, by a processor of an apparatus implemented in a user equipment (UE), a first message (MsgA) in a two-step random access (RA) procedure to a wireless network; and
receiving, by the processor, a second message in the two-step RA procedure, as a response message for MsgA, from the wireless network,
wherein the response message for the MsgA is encoded in a downlink shared channel protocol data unit (DL-SCH PDU) format, including logical channel identifier (LCID) and length (L) (LCID/L) fields, and comprises a medium access control (MAC) control element (CE) carrying a 12-bit timing advance (TA) command.

11. An apparatus implemented in a user equipment (UE), comprising:
a transceiver configured to communicate with a wireless network; and
a processor coupled to the transceiver, the processor configured to perform operations comprising:
transmitting, via the transceiver, a first message (MsgA) in a two-step random access (RA) procedure to the wireless network; and
receiving, via the transceiver, a second message (MsgB) in the two-step RA procedure from the wireless network,
wherein, in an event that the MsgB comprises a RA response (SuccessRAR) indicating a successful contention resolution, one of two R-bits in a backoff subheader as defined in Release 15 (Rel-15) of 3^{rd} Generation Partnership Project (3GPP) specification is set to 1 to identify a SuccessRAR subheader in the RA response.

12. The apparatus of claim 11, wherein a first field in a payload of the SuccessRAR is a UE contention resolution identity field.

13. The apparatus of claim 11, wherein, in an event that the MsgB comprises one or more signaling radio bearer (SRB) messages, the one or more SRB messages are encoded in a format as a downlink shared channel protocol data unit (DL-SCH PDU) with a logical channel identifier (LCID) field and a length (L) field.

14. The apparatus of claim 13, wherein the one or more SRB messages immediately follow a corresponding SuccessRAR that indicates the successful contention resolution.

15. The apparatus of claim 14, wherein the SuccessRAR with the one or more SRB messages constitute a sub-protocol data unit (subPDU) of a last SuccessRAR or a RA response (FallbackRAR) indicating a fallback request that the UE falls back to the four-step RA procedure in a protocol data unit (PDU) of the MsgB.

16. The apparatus of claim 14, wherein whether or not there is at least one SRB message following the SuccessRAR is indicated by a Y-bit in a subheader of the SuccessRAR.

17. The apparatus of claim 11, wherein, within one protocol data unit (PDU) of the MsgB, there is at most one SuccessRAR indicating the successful contention resolution with one or more signaling radio bearer (SRB) messages.

18. The apparatus of claim 11, wherein, in an event that the MsgB comprises a backoff subheader, a content of the backoff subheader in the two-step RA procedure is identical to a content of a backoff subheader in a four-step RA procedure.

19. The apparatus of claim 11, wherein, in an event that the MsgB comprises a RA response (FallbackRAR) indicating a fallback request that the UE falls back to the four-step RA procedure, a format of the FallbackRAR in the two-step RA procedure is identical to a format of a random access preamble identifier (RAPID) subheader and a random access response (RAR) payload in the four-step RA procedure.

20. An apparatus implemented in a user equipment (UE), comprising:
a transceiver configured to communicate with a wireless network; and
a processor coupled to the transceiver, the processor configured to perform operations comprising:
transmitting, via the transceiver, a first message (MsgA) in a two-step random access (RA) procedure to the wireless network; and
receiving, via the transceiver, a second message in the two-step RA procedure, as a response message for MsgA, from the wireless network,
wherein the response message for the MsgA is encoded in a downlink shared channel protocol data unit (DL-SCH PDU) format, including logical channel identifier (LCID) and length (L) (LCID/L) fields, and comprises a medium access control (MAC) control element (CE) carrying a 12-bit timing advance (TA) command.
